(19) United States
(12) Patent Application Publication
(10) Pub. No.: US 2009/0227412 A1
(43) Pub. Date: Sep. 10, 2009

(54) Modular gear train mechanism with an internal motor

(76) Inventor: Din-Shan Chang, Gueishan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/073,744

(22) Filed: Mar. 10, 2008

(51) Int. Cl. F16H 48/06

(52) U.S. Cl. 475/150

(57) ABSTRACT

A modular gear train mechanism with an internal motor includes a hollow casing with an opening, a flywheel, a motor, a fixing gear, a rotating gear and a top cap sealing the opening. The flywheel is mounted between the interior of the top cap and the interior of the casing. A first and a second planet gears are mounted on the exterior of the flywheel pivotally. The motor received in the flywheel has a rotor shaft on which the flywheel is mounted pivotally. The fixing gear is fixed in the flywheel and engages with the first planet gear. The rotating gear is connected to an inner wall of the top cap and engages with the second planet gear. When the rotor shaft turns, the rotating gear is driven to turn and drive the top cap to turn synchronously. Accordingly, the present invention has a reduced volume and is easily used.

### BACKGROUND OF THE INVENTION

1. Field of the Invention

The present invention relates to a train mechanism, especially to a train mechanism with an internal motor.

2. Description of Related Art

Mechanical control systems are widely used in production scheduling in factories, pull in scheduling of trains, antiskid designs for automobiles, temperature control for cold and warm air-conditioners, robots and so on. Train mechanisms are the necessary components in mechanical control systems.

As shown in FIG. 1, a conventional control system generally includes a sensor 1a, a controller 2a, a train mechanism 3a and a controlled field 4a. The controlled field 4a is a mechanical system or electronic system which needs to be controlled. The sensor 1a senses each output state 41a of the controlled field 4a. Each output state 41a and corresponding control commands 5a from a control end are input into the controller 2a. The controller 2a determines the error between the output state 41a and the control commands 5a and outputs a control signal 21a into the train mechanism 3a, so the train mechanism 3a can drive the controlled field 4a to execute the commands 5a from the control end.

Motor train mechanisms are usually used in the control systems. Generally, a motor train mechanism includes a motor and a retarding mechanism which coordinate with each other to reduce the rotary speed of the motor and improve the output torque force of the motor. However, in the conventional motor train mechanism, the motor is disposed outside, which causes that the whole volume of the motor train mechanism is very large. Besides, the space that some controlled fields can provide for connecting the motor train mechanism is limited, so it is inconvenience for mounting the motor train mechanism in the controlled fields.

Additionally, the retarding mechanism of the conventional motor train mechanism consists of a sun gear and a plurality of planet gears engaging with the sun gear and drives the motor to slow down according to different gear ratios of the sun gear and the planet gears, thereby improving the output torque force. Though achieving a desired output torque force, the conventional motor train mechanism has a complex structure, which causes a great friction force and high noise during operation. The greater the friction force is, the more the loss of the output torque force is.

Hence, the inventors of the present invention believe that the shortcomings described above are able to be improved and finally suggest the present invention which is of a reasonable design and is an effective improvement.

### SUMMARY OF THE INVENTION

An object of the present invention is to provide a modular gear train mechanism with an internal motor which has a small volume, simple components, low operation noise and low torque force loss.

To achieving the above-mentioned objects, a modular gear train mechanism with an internal motor in accordance with the present invention is provided. The modular gear train mechanism with an internal motor includes a hollow casing with an opening; a flywheel mounted in the casing, wherein a gear shaft is connected to an exterior of the flywheel and a first planet gear and a second planet gear are mounted on the gear shaft pivotally; a motor received in the flywheel and having a rotor shaft on which the flywheel is mounted pivotally; a fixing gear which is mounted between the exterior of the flywheel and an interior of the casing and fixed on an inner wall of the casing and engages with the first planet gear; a rotating gear rotatably surrounding the flywheel and engaging with the second planet gear; a top cap covering the casing and sealing the opening, the rotating gear connected to an inner wall of the top cap, wherein when the rotating gear turns, the rotating gear drives the top cap to turn; and a plurality of balls which are annularly distributed between the casing and the flywheel and between the casing and the top cap.

The efficacy of the present invention is as follows: since the motor is mounted in the casing, the train mechanism has a small volume, whereby it is convenient for mounting the train mechanism in a controlled field; furthermore, the internal components in the train mechanism have simple structures, so the noise and the friction force produced during the operation of the train mechanism is low, and the low friction force ensure that the loss of the output torque force decrease relatively.

### BRIEF DESCRIPTION OF THE DRAWINGS

FIG. 1 is a block diagram of a conventional control system;

FIG. 2 is an assembled perspective view of a modular gear train mechanism with an internal motor according to the present invention;

FIG. 3 is an exploded perspective view of the modular gear train mechanism with an internal motor according to the present invention;

FIG. 4 is a cross-sectional view of the modular gear train mechanism with an internal motor according to the present invention;

FIG. 5 is an assembled view of a top cap of the present invention;

FIG. 6 is an exploded perspective view of another embodiment of the modular gear train mechanism with an internal motor according to the present invention;

FIG. 7 is a cross-sectional view of another embodiment of the modular gear train mechanism with an internal motor according to the present invention;

FIG. 8 is an assembled view of a bottom cap of the present invention;

FIG. 9 is a schematic view of the modular gear train mechanism with an internal motor according to the present invention, in motion;

FIG. 10 is a first schematic view showing the engagement of the first planet gears, the second planet gears, the rotating gear and the fixing gear of the present invention;

FIG. 11 is a second schematic view showing the engagement of the first planet gears, the second planet gears, the rotating gear and the fixing gear of the present invention;

FIG. 12 is a third schematic view showing the engagement of the first planet gears, the second planet gears, the rotating gear and the fixing gear of the present invention; and

FIG. 13 is a schematic view showing that the present invention is applied to a rotor.

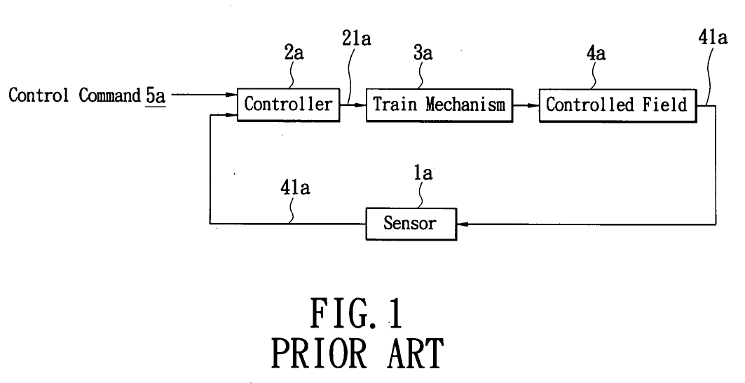

### DETAILED DESCRIPTION OF THE PREFERRED EMBODIMENTS

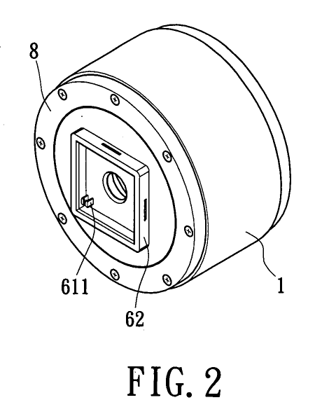

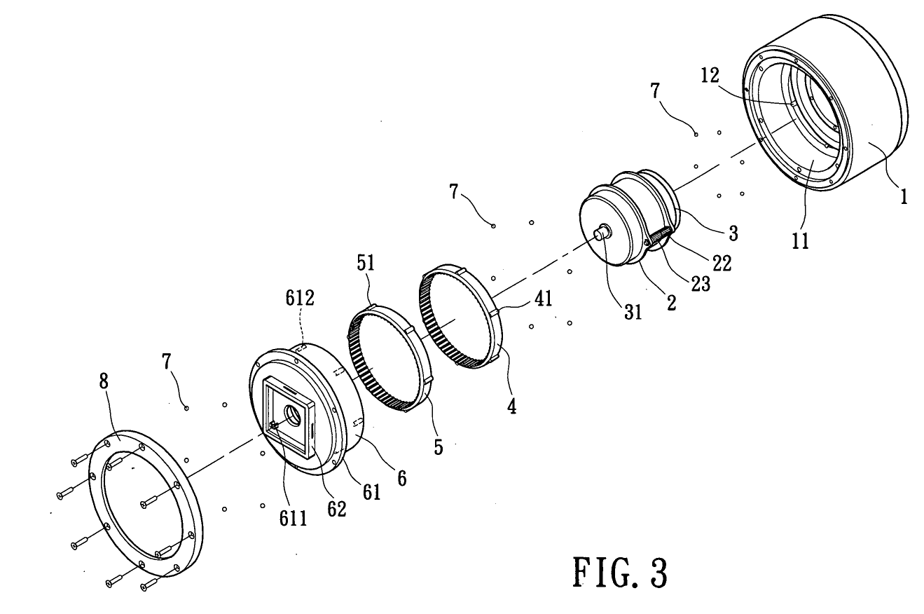

As shown in FIG. 2 and FIG. 3, a modular gear train mechanism with an internal motor according to the present invention includes a hollow casing 1, a flywheel 2, a motor 3, a fixing gear 4, a rotating gear 5, a top cap 6 and a plurality of balls 7. The casing has an opening 11, and the flywheel 2, the motor 3, the fixing gear 4 and the rotating gear 5 are received in the casing 1.

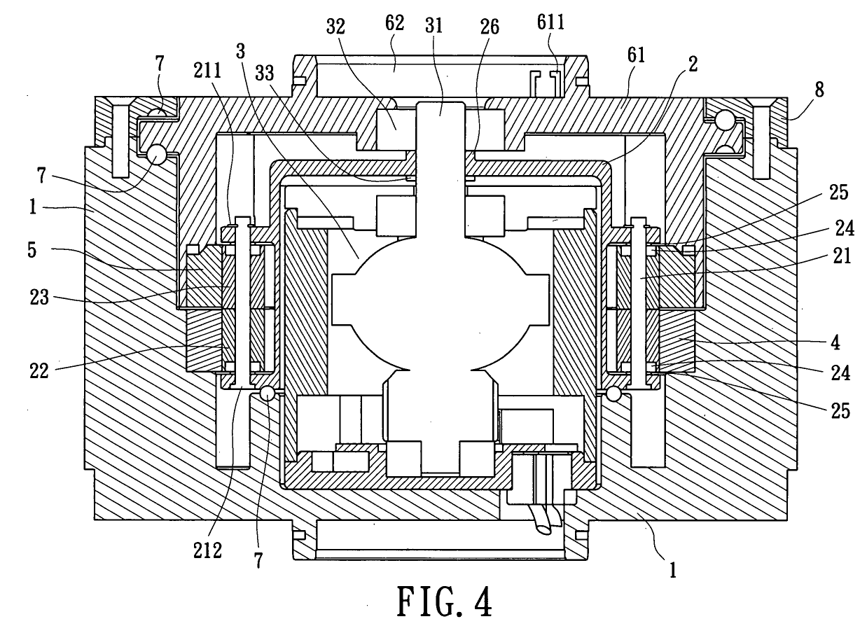

As shown in FIG. 3 and FIG. 4, two gear shafts 21 are connected to the exterior of the flywheel 2. A fastening ring 211 is mounted on one end of each gear shaft 21 to fasten the gear shaft 21 on the surface of the flywheel 2, and a gear shaft base 212 is formed on the other end of each gear shaft 21 and embedded in the flywheel 2.

As shown in FIG. 3 and FIG. 4, a first planet gear 22 and a second planet gear 23, which have the same number of teeth, are mounted on each gear shaft 21 pivotally. Two first bearings 24 are respectively mounted on two corresponding ends of each gear shaft 21. The first planet gear 22 and the second planet gear 23 are located between the two first bearings 24. The corresponding two ends of each gear shaft 21 further pass through two wear resistance pieces 25 which are located between the two first shafts 24 and the flywheel 2, respectively. The flywheel 2 has a protruding portion 26 protruding from the exterior thereof.

As shown in FIG. 3 and FIG. 4, the motor 3 is received in the flywheel 2 and includes a rotor shaft 31 extending out of the protruding portion 26 of the flywheel 2. The rotor shaft 31 is pivotally connected with a second bearing 32 which is mounted on the top cap 6. The flywheel 2 is mounted on the rotor shaft 31 pivotally via the second bearing 32. The second bearing 32 abuts against the protruding portion 26. The rotor shaft 31 further passes through a gasket 33 located between the interior of the flywheel 2 and the exterior of the motor 3.

As shown in FIG. 3 and FIG. 4, a plurality of long-strip-shaped grooves 12 is annularly arranged at intervals in the inner wall of the casing 1. The fixing gear 4 surrounding the flywheel 2 has a plurality of protruding strips 41 which is formed at intervals in the outer wall of the fixing gear 4, corresponding to the grooves 12. The protruding strips 41 engages with the grooves 12 so that the fixing gear 4 is fixed in the casing 1 and engages with the two first planet gears 22. The rotating gear 5 is rotatably mounted between the exterior of the flywheel 2 and the interior of the top cap 6 and engages with the two second planet gears 23. When turning, the second planet gears 23 drive the rotating gear 5 to turn synchronously. The teeth of the fixing gear 4 must be less than that of the rotating gear 5 to produce a gear reduction ratio, thereby the rotor shaft 31 can decelerate.

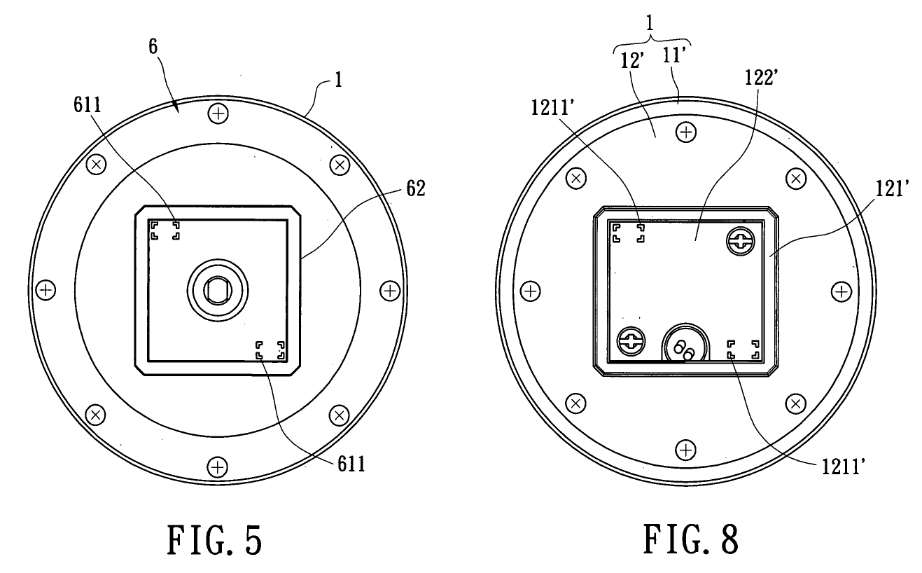

As shown in FIG. 3 and FIG. 5, the top cap 6 includes a first base portion 61 and a first plate body 62. The first base portion 61 has two first tenons 611 which are jointed on two diagonal positions of the first plate body 62, respectively. The first base portion 61 of the top cap 6 covers the casing 1 and seals the opening 11. The first base portion 61 extends into the casing 1 and has a plurality of long-strip-shaped grooves 612 annularly arranged at intervals in the inner wall thereof. The rotating gear 5 has a plurality of protruding strips 51 formed at intervals in the outer wall thereof, corresponding to the grooves 612. The protruding strips 51 engage with the grooves 612 so that the rotating gear 5 is connected to the inner wall of the top cap 6. When the rotating gear 5 turns, it drives the top cap 6 to turn synchronously.

As shown in FIG. 3 and FIG. 4, the casing 1, the first planet gears 22, the second planet gears 23, the fixing gear 4, the rotating gear 5 and the top cap 6 are made of engineering plastics. The balls 7 are made of steel and have great supporting forces and high reliability. The balls 7 are annularly distributed between the casing 1 and the flywheel 2 and between the casing 1 and the top cap 6. The balls 7 are used as sliding mediums, which are coated with lubricating oil to reduce friction forces between the balls and the casing 1, the flywheel 2 and the top cap 6. The present invention further includes a fixing ring 8 which is locked on the exterior of the casing 1 via grub screws with hexagon holes to surround the top cap 6, and the balls 7 are annularly distributed between the top cap 6 and the fixing ring 8.

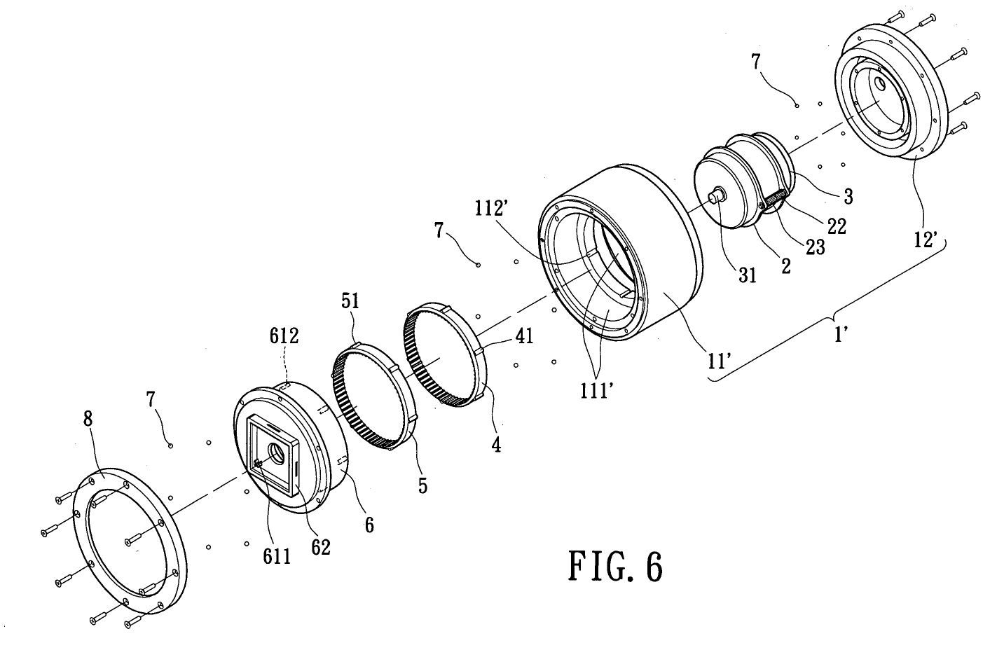

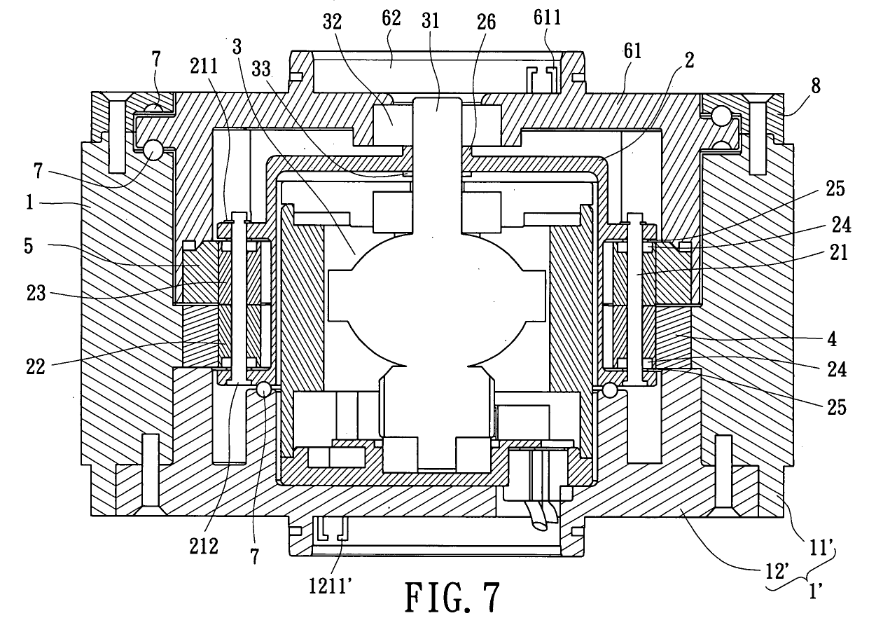

As shown in FIGS. 6-8, in another embodiment, the casing 1′ includes a hollow body 11′ and a bottom cap 12′. The hollow body 11′ has two openings 111′ respectively formed in two corresponding ends thereof. A plurality of long-strip-shaped grooves 112′ is annularly arranged at intervals in the inner wall of the hollow body 11′, corresponding to the protruding strips 41. The protruding strips 41 of the fixing gear 4 engage with the grooves 112′ to fix the fixing gear 4 in the hollow body 11′. The bottom cap 12′ is fixed on one of the openings 111′ of the hollow body 11′ and seals the opening 111′. The bottom cap 12′ includes a second base portion 121′ and a second plate body 122′. The second base portion 121′ has two second tenons 1211′ which are jointed on two diagonal positions of the second plate body 122′, respectively. The motor 3 is locked on the other diagonal positions of the second plate body 122′ via screws. The balls 7 are annularly distributed between the hollow body 11′ and the top cap 6 and between the bottom cap 12′ and the flywheel 2. The fixing ring 8 is locked on the exterior of the hollow body 11′ via grub screws with hexagon holes.

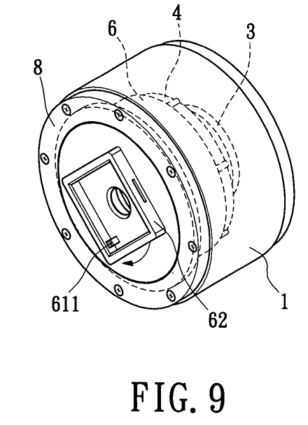

As shown in FIG. 4 and FIG. 9, when the motor 3 is electrically connected to an external power source (not shown), the rotor shaft 31 of the motor 3 starts to turn and drives the flywheel 2 to turn. When the fly wheel 2 turns, the first planet gear 22 and the second planet gear 23 respectively engaging with the fixing gear 4 and the rotating gear 5 will turn on the gear shaft 21. At this time, the fixing gear 4 is stationary in the casing 1 and the second planet gear 23 drives the rotating gear 5 to turn. When the rotating gear 5 turns, it will drive the top cap 6 to turn synchronously. By the way, a screw may be connected with the output end (the top cap 6) of the train mechanism and driven to move linearly and telescopically (not shown) by the train mechanism.

It is worthwhile to mention that the two first planet gears 22, the two second planet gears 23, the fixing gear 4 and the rotating gear5 have specially designed tooth shapes. Otherwise, when the first planet gears 22 and the second planet gears 23 turn, the fixing gear 4 and the rotating gear 5 cannot be in the correct states, that is, one gear is stationary and the other gear is in motion. The design for the tooth shapes of the gears is as follows:

1. The first planet gears 22 and the second planet gears 23 have convex teeth with the same tooth shape, of which side appearances are slightly shaped like an isosceles trapezoid.

2. Side appearances of convex teeth of the fixing gear 4 and the rotating gear 5 are slightly shaped like isosceles trapezoids, and the tooth width of the convex teeth of the fixing gear 4 is slightly greater than that of the convex teeth of the rotating gear 5.

3. The maximum tooth width of the convex teeth of the fixing gear 4 and the rotating gear 5 is greater than that of the convex teeth of the first planet gears 22 and the second planet gears 23.

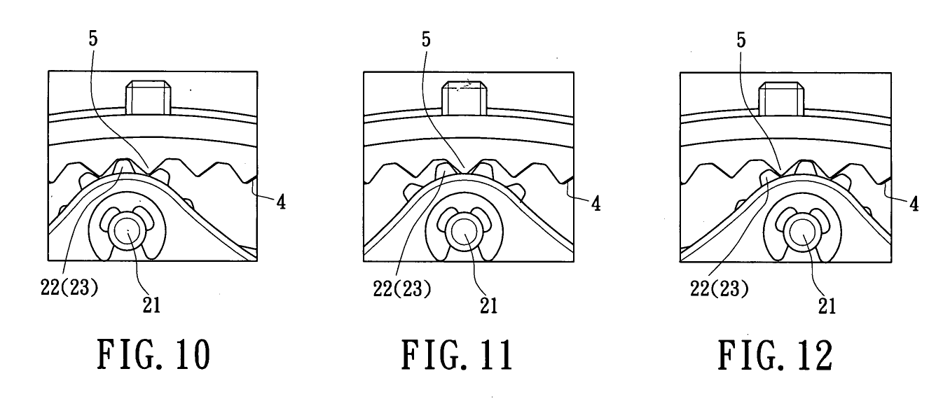

As shown in FIG. 10, the convex teeth of the first planet gears 22 and the second planet gears 23 respectively extend into tooth seams between adjacent convex teeth of the fixing gear 4 and the rotating gear 5. The tops of the convex teeth of the first planet gears 22 and the second planet gears 23 respectively collide with the bottoms of the tooth seams of the fixing gear 4 and the rotating gear 5. As shown in FIG. 11, then the side portions of the convex teeth of the first planet gears 22 and the second planet gears 23 respectively collide with the side portions of the convex teeth of the fixing gear 4 and the rotating gear 5. As shown in FIG. 12, finally, the side portions of the convex teeth of the first planet gears 22 and the second planet gears 23 respectively move to the tops of the convex teeth of the fixing gear 4 and the rotating gear 5 along the side portions of the convex teeth of the fixing gear 4 and the rotating gear 5, thereby the convex teeth of the first planet gears 22 and the second planet gears 23 respectively extend into next tooth seams of the fixing gear 4 and the rotating gear 5.

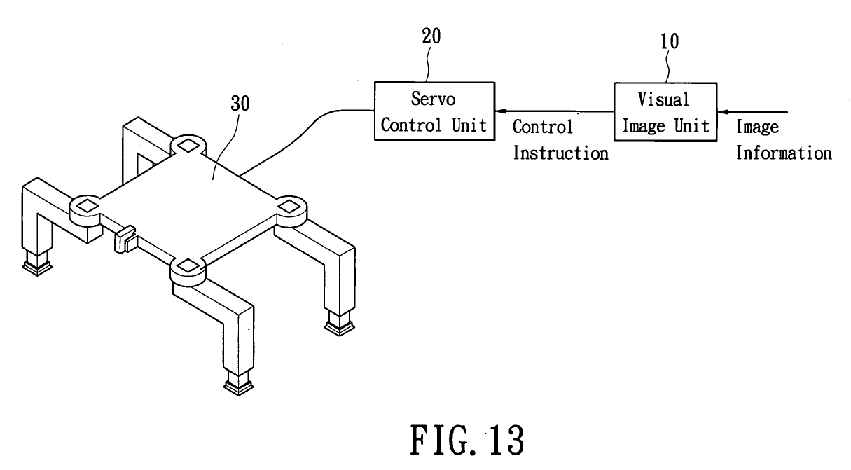

As shown in FIG. 13, the train mechanism of the present invention coordinates with a visual image unit 10 and a servo control unit 20 to control a robot 30. The train mechanism of the present invention is mounted on each action joint of the robot 30. The signal transmission between the visual image unit 10, the servo control unit 20 and the modular train mechanism is achieved according to the RS-232 serial communication protocol or the RS-485 serial communication protocol. Assuming that the robot 30's task is to move to a destination along the shortest path, the visual image unit 10 determines external image information and plans the shortest path to the destination, and the servo control unit 20 determines the information for the shortest path and outputs a proper control force to the train mechanisms mounted on the robot 30, so that the train mechanisms drive the robot 30 to move along the shortest path planned by the visual image unit 10.

Consequently, the advantages of the modular gear train mechanism with an internal motor of the present invention are as follows:

1. The motor 3 is mounted in the casing 1, so the train mechanism has a small volume, whereby it is convenient for mounting the train mechanism in a controlled field. Furthermore, the internal components in the train mechanism have simple structures, so the noise and the friction force produced during the operation of the train mechanism is low, and the low friction force ensure that the loss of the output torque force decrease relatively.

2. The casing 1, the first planet gears 22, the second planet gears 23, the fixing gear 4, the rotating gear 5 and the top cap 6 are made of engineering plastics which has a low cost, high plasticity and high intensity and ensures that the noise cause by friction and collision of the components is low.

3. The protruding portion 26 is formed to avoid direction friction between the second bearing 32 and the flywheel 2.

4. The wear resistance pieces 25 are mounted to reduce the friction force between the first bearing 24 and the flywheel 2.

5. The gasket 33 reduces the friction force produced when the flywheel 2 and the rotor shaft 31 contact with each other.

What are disclosed above are only the specification and the drawings of the preferred embodiments of the present invention and it is therefore not intended that the present invention be limited to the particular embodiments disclosed. It will be understood by those skilled in the art that various equivalent changes may be made depending on the specification and the drawings of the present invention without departing from the scope of the present invention.

What is claimed is:

1. A modular gear train mechanism with an internal motor, comprising:
a hollow casing with an opening;
a flywheel mounted in the casing, a gear shaft connected to an exterior of the flywheel and a first planet gear and a second planet gear mounted pivotally on the gear shaft;
a motor, received in the flywheel and having a rotor shaft on which the flywheel is mounted pivotally;
a fixing gear, mounted between the exterior of the flywheel and an interior of the casing, fixed on an inner wall of the casing and engaging with the first planet gear;
a rotating gear, rotatingly surrounding the flywheel and engaging with the second planet gear;
a top cap, covering the casing and sealing the opening, the rotating gear connected to an inner wall of the top cap, wherein when the rotating gear turns, the rotating gear drives the top cap to turn; and
a plurality of balls, annularly distributed between the casing and the flywheel and between the casing and the top cap.

2. The modular gear train mechanism as claimed in claim 1, wherein the rotating gear has more teeth than the fixing gear.

3. The modular gear train mechanism as claimed in claim 1, wherein two first bearings are pivotally mounted on two ends of the gear shaft respectively, and the first planet gear and the second planet gear are located between the two first bearings.

4. The modular gear train mechanism as claimed in claim 1, wherein the rotor shaft is pivotally connected with a second bearing which is mounted on the top cap, the flywheel has a protruding portion protruding from the exterior thereof, and the rotor shaft extends out of the protruding portion and the second bearing abuts against the protruding portion.

5. The modular gear train mechanism as claimed in claim 1, wherein the balls are made of steel and coated with lubricating oil.

6. The modular gear train mechanism as claimed in claim 1, wherein the top cap, the casing, the first planet gear, the second planet gear, the fixing gear and the rotating gear are made of engineering plastics.

7. The modular gear train mechanism as claimed in claim 1, wherein the rotor shaft passes through a gasket located between the flywheel and the motor.

8. The modular gear train mechanism as claimed in claim 1, wherein a fastening ring is mounted on one end of the gear shaft to fasten the gear shaft on the flywheel, and a gear shaft base is formed on the other end of the gear shaft and embedded in the flywheel.

9. The modular gear train mechanism as claimed in claim 3, wherein the gear shaft passes through two wear resistance pieces which are located between the first bearings and the flywheel, respectively.

10. The modular gear train mechanism as claimed in claim 1, wherein the top cap includes a first base portion and a first plate body, and the first base portion has two first tenons which are respectively jointed on the first plate body.

11. The modular gear train mechanism as claimed in claim 1, further comprising a fixing ring fixed on an exterior of the casing and surrounding the top cap, the balls distributed between the fixing ring and the top cap.

12. The modular gear train mechanism as claimed in claim 1, wherein the casing includes a hollow body and a bottom cap, and the hollow body has two openings respectively formed in two corresponding ends thereof, the bottom cap is fixed on one of the openings of the hollow body and seals the opening, and the balls are annularly distributed between the hollow body and the top cap and between the bottom cap and the flywheel.

13. The modular gear train mechanism as claimed in claim 12, wherein the bottom cap includes a second base portion and a second plate body, and the second base portion has two second tenons which are respectively jointed on the second plate body and the motor is fixed on the second plate body.

14. The modular gear train mechanism as claimed in claim 12, further comprising a fixing ring fixed on an exterior of the hollow body.
